(19) United States
(12) Patent Application Publication
(10) Pub. No.: US 2021/0404348 A1
(43) Pub. Date: Dec. 30, 2021

(54) TURBINE ENGINE SEALING AND METHOD

(71) Applicant: GE Avio S.r.l., Rivalta di Torino (IT)

(72) Inventors: Alberto Buonvino, Turin (IT); Luca Giacobone, Turin (IT); Daniele Coutandin, Avigliana (IT)

(21) Appl. No.: 17/307,262

(22) Filed: May 4, 2021

(30) Foreign Application Priority Data
Jun. 23, 2020 (IT) 102020000015079

(51) Int. Cl. F01D 25/12; F01D 11/24; F01D 11/02

(52) U.S. Cl. CPC F01D 25/12; F01D 11/24; F05D 2260/201; F05D 2220/323; F01D 11/025

(57) ABSTRACT

Aspects of the disclosure generally relate to a turbine engine and method of operating, wherein a change in sealing status can be determined within a cavity between an outer casing and a rotor within the turbine engine. Aspects of the disclosure further relate to a supply of air to the cavity within the turbine engine.

### CROSS-REFERENCE TO RELATED APPLICATION(S)

This application claims priority to Italian Patent Application No. 102020000015079, filed Jun. 23, 2020, which is incorporated herein by reference in its entirety.

### STATEMENT REGARDING FEDERALLY SPONSORED RESEARCH OR DEVELOPMENT

The project leading to this application has received funding from the Clean Sky 2 Joint Undertaking under the European Union's Horizon 2020 research and innovation program under grant agreement No. CS2-LPA-GAM-2018/2019-01.

### TECHNICAL FIELD

The disclosure relates to methods of operating a turbine engine, including determining a sealing status within the engine.

### BACKGROUND

Turbine engines, and particularly gas or combustion turbine engines, are rotary engines that extract energy from a flow of combusted gases passing through the engine onto a multitude of rotating turbine blades.

A turbine engine can include, in serial flow arrangement, a forward fan assembly, an aft fan assembly, at least one compressor for compressing air flowing through the engine, a combustor for mixing fuel with the compressed air such that the mixture may be ignited, and at least one turbine. The at least one compressor, combustor and at least one turbine are sometimes collectively referred to as the core engine. In operation, the core engine generates combustion gases which are discharged downstream to a turbine section extracting energy therefrom for powering the forward and aft fan assemblies. Turbine engines can also include pressurized cavities supplied with cooling air and sealed from combustion airflows within the engine.

The compressor and turbine sections of the turbine engine typically include multiple, serially arranged stages, with each stage comprising cooperating sets of circumferentially airfoils, with one set axially spaced from the other set. In a turbine engine with a rotor surrounded by a stator, the first set of airfoils includes a set of blades that rotate about the engine centerline, and the second set of airfoils includes a set of stationary vanes. In a counter-rotating turbine engine, both sets of airfoils can be in the form of sets of blades, with each set rotating in opposite directions. In such a case, the counter-rotating turbine can include an outer rotor having the first set of airfoils that are rotatably coupled to the forward fan assembly, as well as an inner rotor having the second set of airfoils rotatably coupled to the aft fan assembly. The outer rotor can be spaced from an outer casing of the engine, and cooling can be provided therebetween.

### BRIEF DESCRIPTION

In one aspect, the disclosure relates to a method of operating a turbine engine. The method includes determining a change in sealing status within a cavity at least partially defined between an outer casing and a rotor within the turbine engine, and increasing a supply of cooling air to the cavity based on the determined change in sealing status.

In another aspect, the disclosure relates to a method of operating a turbine engine. The method includes sensing a first environmental parameter within a cavity in the turbine engine, determining a change in sealing status in the cavity based at least on the first environmental parameter, determining a needed supply of cooling air to the cavity based on the change in sealing status, and operating a valve fluidly coupled to the cavity to provide the needed supply of cooling air.

In yet another aspect, the disclosure relates to a turbine engine, including an outer casing having a casing surface bounding an interior, a first rotor located within the outer casing and having a rotor surface spaced from the casing surface, at least one seal extending between the casing surface and the rotor surface, a cavity at least partially defined between the rotor surface, the casing surface, and the at least one seal, an inlet passage fluidly coupled to the cavity, a controllable valve located within the inlet passage, at least one sensor located within the cavity and configured to provide a signal indicative of an environmental parameter; and a controller configured to receive the signal, to determine a change in sealing status of the at least one seal, and to operate the controllable valve based on the change in sealing status.

### BRIEF DESCRIPTION OF THE DRAWINGS

In the drawings:

FIG. 1 is a schematic cross-sectional diagram of a turbine engine including a counter-rotating turbine section in accordance with various aspects described herein.

FIG. 2 is a schematic view of a portion of the counter-rotating turbine section of FIG. 1.

FIG. 3 is an enlarged view of the portion of the counter-rotating turbine section of FIG. 2 illustrating airflows in accordance with various aspects described herein.

FIG. 4 is a flowchart illustrating a method of operating the turbine engine of FIG. 1 in accordance with various aspects described herein.

FIG. 5 is a flowchart illustrating another method of operating the turbine engine of FIG. 1 in accordance with various aspects described herein.

### DETAILED DESCRIPTION

Aspects of the disclosure described herein are directed to an apparatus and method for determining a sealing status or failure within an engine. For the purposes of illustration, one exemplary environment within which aspects of the disclosure an be utilized will be described in the form of a turbine engine. Such a turbine engine can be in the form of a gas turbine engine, a turboprop, turboshaft or a turbofan engine, in non-limiting examples. It will be understood, however, that aspects of the disclosure described herein are not so limited and can have general applicability within other environments. For example, the disclosure can have applicability in other engines or vehicles, and may be used to provide benefits in industrial, commercial, and residential applications.

Turbine engines can have cooled cavities fluidly separated or sealed from a hot gas path through the engine. Cooling air can flow into the cavity for a variety of purposes, including protection of instruments in the cavity from high-temperature environments or supplying cooling air to other regions of the engine, in non-limiting examples. In the event of a change in sealing status, performance, function, or the like, hot gases within the engine core may be ingested into such cavities. Engine handling in the event of such a change has traditionally been addressed by an engine controller shutting down the engine until further inspection is available. For example, a planned component release can be performed within the engine in response to a determined change in sealing status.

Aspects of the disclosure provide for an apparatus and method for addressing such a change in sealing status, performance, or function within an engine cavity. Such a change can be detected or determined, for example by a sensor or a controller, and a supply of cooling air to the cavity can be modified in response to such a detected or determined change in sealing performance so as to prevent ingestion of hot gases into the cavity.

As used herein, the term “upstream” refers to a direction that is opposite a fluid flow direction, and the term “downstream” refers to a direction that is in the same direction as the fluid flow. The term “fore” or “forward” refers to a direction or position in front of a component, and “aft” or “rearward” refers to a direction or position behind a component. For example, when used in terms of fluid flow, fore/forward can mean upstream and aft/rearward can mean downstream.

Additionally, as used herein, the terms “radial” or “radially” refer to a direction away from a common center. For example, in the overall context of a turbine engine, radial refers to a direction along a ray extending between a center longitudinal axis of the engine and an outer engine circumference. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are used only for identification purposes to aid the reader's understanding of the present disclosure, and should not be construed as limiting on an embodiment, particularly as to the position, orientation, or use of aspects of the disclosure described herein. Connection references (e.g., attached, coupled, fixed, connected, joined, and the like) are to be construed broadly and can include intermediate members between a collection of elements and relative movement between elements unless otherwise indicated. As such, connection references do not necessarily infer that two elements are directly connected and in fixed relation to one another. The singular forms “a,” “an,” and “the” include plural references unless the context clearly dictates otherwise.

Additionally, as used herein, a “controller” or “controller module” can include a component configured or adapted to provide instruction, control, operation, or any form of communication for operable components to effect the operation thereof. A controller module can include any known processor, microcontroller, or logic device, including, but not limited to: field programmable gate arrays (FPGA), an application specific integrated circuit (ASIC), a full authority digital engine control (FADEC), a proportional controller (P), a proportional integral controller (PI), a proportional derivative controller (PD), a proportional integral derivative controller (PID controller), a hardware-accelerated logic controller (e.g. for encoding, decoding, transcoding, etc.), the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a controller module can also include a data storage component accessible by the processor, including memory, whether transient, volatile or non-transient, or non-volatile memory. Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to effect a functional or operable outcome, as described herein.

Additionally, as used herein, elements being “electrically connected,” “electrically coupled,” or “in signal communication” can include an electric transmission or signal being sent, received, or communicated to or from such connected or coupled elements.

Furthermore, such electrical connections or couplings can include a wired or wireless connection, or a combination thereof.

Also, as used herein, while sensors can be described as “sensing” or “measuring” a respective value, sensing or measuring can include determining a value indicative of or related to the respective value, rather than directly sensing or measuring the value itself. The sensed or measured values can further be provided to additional components. For instance, the value can be provided to a controller module or processor as defined above, and the controller module or processor can perform processing on the value to determine a representative value or an electrical characteristic representative of said value.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

The exemplary drawings are for purposes of illustration only and the dimensions, positions, order and relative sizes reflected in the drawings attached hereto can vary.

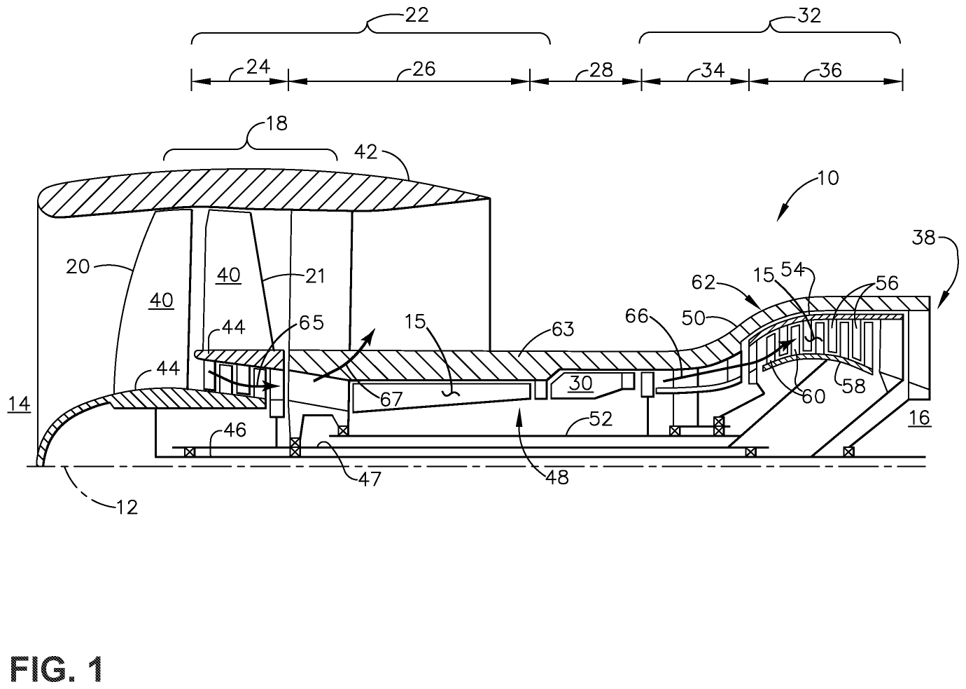

FIG. 1 is a schematic cross-sectional diagram of a gas turbine engine 10 for an aircraft. The turbine engine 10 has a generally longitudinally extending axis or centerline 12 extending from a forward direction 14 to an aft direction 16. The engine 10 includes, in downstream serial flow relationship, a fan section 18 including a forward fan assembly 20 and an aft fan assembly 21, a compressor section 22 including a booster or low pressure (LP) compressor 24 and a high pressure (HP) compressor 26, a combustion section 28 including a combustor 30, a turbine section 32 including a HP turbine 34 and an LP turbine 36, and an exhaust section 38.

The fan assemblies 20 and 21 are positioned at a forward end of the turbine engine 10 as illustrated. The terms “forward fan” and “aft fan” are used herein to indicate that one of the fans 20 is coupled axially upstream from the other fan 21. It is also contemplated that the fan assemblies 20, 21 can be positioned at an aft end of turbine engine 10. Fan assemblies 20 and 21 each include a plurality of rows of fan blades 40 positioned within a fan casing 42. Fan blades 40 are joined to respective rotor disks 44 that are rotatably coupled through a respective forward fan shaft 46 to the forward fan assembly 40 and through an aft fan shaft 47 to the aft fan assembly 21.

The HP compressor 26, the combustor 30, and the HP turbine 34 form an engine core 48 of the engine 10. The engine core 48 is surrounded by an outer casing 50 that can be coupled with the fan casing 40. The HP turbine 34 is coupled to the HP compressor 26 via a core rotor or shaft 52. In operation, the engine core 48 generates combustion gases that are channeled downstream to the counter-rotating LP turbine 36 which extracts energy from the gases for powering fan assemblies 20, 21 through their respective fan shafts 46, 47.

In the example shown, the LP turbine 36 is in the form of a counter-rotating turbine. It will be understood that aspects of the disclosure can have applicability toward other turbines, including engines without counter-rotating LP turbines. For example, turbine engines having LP turbines in which static circumferentially-arranged vanes are axially spaced from rotating circumferentially-arranged blades are also contemplated. Furthermore, a turbine engine having a counter-rotating compressor section 22, in particular either a counter-rotating LP compressor 24 or a counter-rotating HP compressor 26, is also contemplated.

The LP turbine 36 includes a first rotor in the form of an outer rotor 54 positioned radially inward from the outer casing 50. The first rotor 54 can have a generally frusto-conical shape and include a first set of airfoils 56, circumferentially arranged, that extend radially inwardly towards the axial centerline 12.

The LP turbine 36 further includes a second rotor in the form of an inner rotor 58 arranged substantially coaxially with respect to, and radially inward of, the outer rotor 54. The inner rotor 58 includes a second set of airfoils 60 circumferentially arranged and axially spaced from the first set of airfoils 56. The second set of airfoils 60 extend radially outwardly away from the axial centerline 12. The first and second sets of airfoils 56, 60 together define a plurality of turbine stages 62. In the example of FIG. 1, five turbine stages 62 are shown, and it will be understood that any number of stages can be utilized. Furthermore, while the first set of airfoils 56 are illustrated as being forward of the second set of airfoils 60, the first and second sets of airfoils 56, 60 can be arranged in any suitable manner, including the first set of airfoils 56 being positioned aft of the second set of airfoils 60.

While the turbine engine 10 is described in the context of including a rotating outer rotor 54 and rotating inner rotor 58, it is further contemplated that either of the first set of airfoils 56 or the second set of airfoils 60 can be included in, or form part of, a fixed stator within the engine 10. In one example, the first set of airfoils 56 can form a set of circumferentially-arranged static vanes forming part of an outer stator within the engine 10, while the second set of airfoils 60 is coupled to the rotatable inner rotor 58. In another example, the second set of airfoils 60 can be in the form of static vanes coupled to an inner stator within the engine 10, with the first set of airfoils 56 being in the form of blades coupled to an outer rotor.

Complementary to the outer rotor 54 and inner rotor 58, the stationary portions of the engine 10, such as the outer casing 50, are also referred to individually or collectively as a stator 63. As such, the stator 63 can refer to the combination of non-rotating elements throughout the engine 10.

In operation, the airflow exiting the fan section 18 is split such that a portion of the airflow is channeled along a main flow path 15 into the LP compressor 24, which then supplies pressurized air 65 to the HP compressor 26, which further pressurizes the air. The pressurized air 65 from the HP compressor 26 is mixed with fuel in the combustor 30 and ignited, thereby generating combustion gases 66 along the main flow path 15. Some work is extracted from these gases 66 by the HP turbine 34, which drives the HP compressor 26. The combustion gases 66 are discharged along the main flow path 15 into the LP turbine 36, which extracts additional work to drive the LP compressor 24, and the exhaust gas is ultimately discharged from the engine 10 via the exhaust section 38. The driving of the LP turbine 36 can drive rotation of the fan 20 and the LP compressor 24.

A portion of the pressurized airflow 65 can be drawn from the compressor section 22 as bleed air 67. The bleed air 67 can be drawn from the pressurized airflow 65 and provided to engine components requiring cooling. The temperature of pressurized airflow 65 entering the combustor 30 is significantly increased above the bleed air 67 temperature. The bleed air 67 may be used to reduce the temperature of the core components downstream of the combustor.

Some of the air supplied by the fan 20, such as the bleed air 67, can bypass the engine core 48 and be used for cooling of portions, especially hot portions, of the engine 10, or for cooling or powering other portions of the engine 10. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

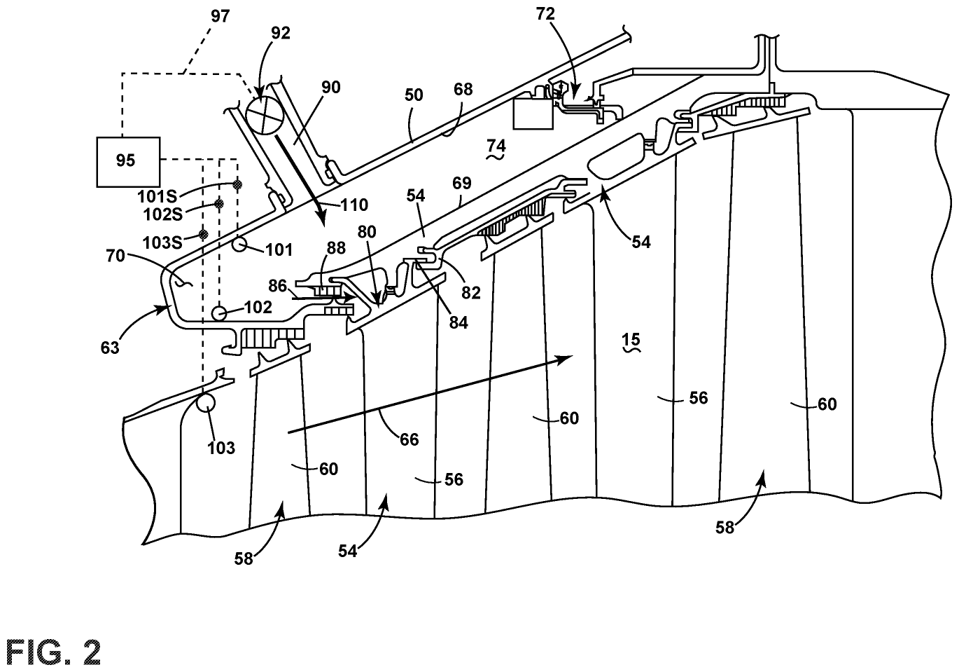

FIG. 2 is an enlarged schematic view of a portion of the counter-rotating LP turbine 36. The outer casing 50 includes a casing surface 68, and the outer rotor 54 has a rotor surface 69 facing the casing surface 68.

At least one seal 72 can be provided within the cavity 74 between the outer casing 50 and outer rotor 54. A cavity 74 can be at least partially defined between the outer casing 50, the outer rotor 54, and the at least one seal 72. The cavity 74 can extend at least circumferentially within the engine 10 including, but not limited to, a fully annular cavity 74 or multiple circumferentially-spaced cavities 74. The seal 72 can have any suitable form or material including, but not limited to, a composite steel ring, a nickel alloy ring, or an aspirating face seal (AFS). In one example, the seal 72 can have an annular form and circumscribe the entire outer rotor 54. In another example, the seal 72 can include multiple segments that each partially circumscribe the outer rotor 54. It is also contemplated that the cavity 74 formed by the at least one seal 72 can also circumscribe the entire outer rotor 54 or be located at varying points around the outer rotor 54. Furthermore, the cavity 74 can be intermittently sealed during operation of the engine 10, such as via periodic sealing and unsealing during rotation of the outer rotor 54 and inner rotor 58, or the cavity 74 can be constantly sealed during operation.

By way of non-limiting example, the first set of airfoils 56 can be mounted to the outer rotor 54 via at least one hanger assembly 80. It should be appreciated that multiple hanger assemblies 80 can be provided and arranged circumferentially or axially within the LP turbine 36. Each hanger assembly 80 can include a hook 82 extending from the outer rotor 54. A set of airfoils, such as the first set of airfoils 56, can terminate in a flange 84 configured to be received within the hook 82, thereby securing the first set of airfoils 56 to the outer rotor 54. It should be understood that the first set of airfoils 56 can be mounted to the outer rotor 54 in any suitable manner. It is further contemplated that the hanger assembly 80 can utilize an interference fit with slots in one of the hook 82 or flange 84. In addition, while the hanger assembly 80 is discussed in the context of the first set of airfoils 56, the hanger assembly 80 can also be utilized to secure the second set of airfoils 60 to the inner rotor 58 (FIG. 1).

A purge path 86 be provided fluidly coupling the cavity 74 to the main flow path 15 through the turbine engine 10. As illustrated, the purge path 86 is at least partially defined by the outer rotor 54. More specifically, the purge path 86 is defined by a portion of the outer casing 50 confronting a portion of the hanger assembly 80. A seal element 88, such as a honeycomb seal, can be provided along the portion of the hanger assembly 80 to at least partially fluidly isolate the cavity 74 from the main flow path 15.

An inlet passage 90 can be fluidly coupled to the cavity 74 for supplying pressurized air or cooling air to the cavity 74. A valve 92 can be located within the inlet passage 90 for controlling the supply of cooling air. The valve 92 can have any suitable form for the provision of air through the inlet passage 90. In one example, the valve 92 can be movable between a fully-closed position that blocks the flow of cooling air and a fully-open position that permits the flow of cooling air. In another example, the valve 92 can include an aperture movable between a first open position, allowing a first supply of cooling air, and a second open position, allowing a second supply of cooling air greater than the first supply. In non-limiting examples, the valve 92 can be in the form of a flow control valve, check valve, poppet valve, or thermal expansion valve.

It is contemplated that the valve 92 can be in the form of a controllable valve. In the example shown, a controller 95 is provided and electrically coupled to the valve 92 via lines 97, which are illustrated in dashed line. It will be understood that data signals, measurement signals, control signals, or the like can be transmitted along the lines 97, and that the lines 97 can represent wired or wireless signal communication between coupled elements.

Furthermore, at least one sensor can be located within the cavity 74. More specifically, a first sensor 101 is positioned within the cavity 74 adjacent the inlet passage 90, a second sensor 102 is positioned within the cavity 74 near the purge path 86, and a third sensor 103 is positioned within the main flow path 15. The first, second, and third sensors 101, 102, 103 can be electrically coupled to the controller 95 via lines 97 as shown. In addition, the first, second, and third sensors 101, 102, 103 can include any suitable sensor including, but not limited to, a thermocouple, a radiation pyrometer, an infrared sensor, an optical sensor, a radiation sensor, an accelerometer, an exhaust gas temperature (EGT) sensor, a pressure sensor, an acoustic sensor, or the like.

Any or all of the first sensor 101, second sensor 102, or third sensor 103 can be configured to sense at least one environmental parameter and to transmit a signal indicative of the at least one environmental parameter. Examples of such an environmental parameter include, but are not limited to, fluid temperature, fluid pressure, vibration level, noise level, electromagnetic radiation sensing e.g. visible light or infrared light, or the like, or combinations thereof. The controller 95 can be configured to receive signals from any or all of the first sensor 102, second sensor 102, or third sensor 103. The controller 95 can be further configured to controllably operate the valve 92, including opening, closing, or otherwise modifying a flow through the valve 92.

During operation, cooling air 110 can flow through the valve 92 and inlet passage 90 and enter the cavity 74. At least one of the first, second, or third sensors 101, 102, 103 can provide a signal to the controller 95 indicative of an environmental parameter at the sensor location. For the purposes of illustration, one working example will be discussed wherein the first sensor 101 senses an air temperature within the cavity 74, the second sensor 102 senses an air pressure within the cavity 74, and the third sensor 103 senses an air temperature in the main flow path 15. It will be understood that the disclosure is not so limited and that the first, second, and third sensors 101, 102, 103 can be utilized to sense any suitable environmental parameter as described above. For example, it is contemplated that each of the first sensor 101, second sensor 102, and third sensor 103 can sense an air temperature at their respective locations within the engine 10.

The controller 95 can receive signals transmitted by any or all of the sensors 101, 102, 103. For example, the first sensor 101 can transmit a first signal 101S indicative of an environmental parameter, e.g. the air temperature within the cavity 74. The second sensor 102 can transmit a second signal 102S indicative of an environmental parameter, e.g. the air pressure within the cavity 74. The third sensor 103 can transmit a third signal 103S indicative of an environmental parameter, e.g. the air temperature within the main flow path 15. The controller 95 can receive the first signal 101S, second signal 102S, and third signal 103S. The controller 95 can also operate the valve 92 to supply a predetermined amount of cooling air 110 to the cavity 74 based on any or all of the received signals 101S, 102S, 103S. For example, the controller 95 can perform a comparison of any or all of the first signal 101S, second signal 102S, or third signal 103S with a threshold value indicative of a nominal sealing status. As used herein, “nominal sealing status” will refer to a standard working status, performance, or function of the seal 72 to fluidly isolate the cavity 74 during normal operation of the engine 10.

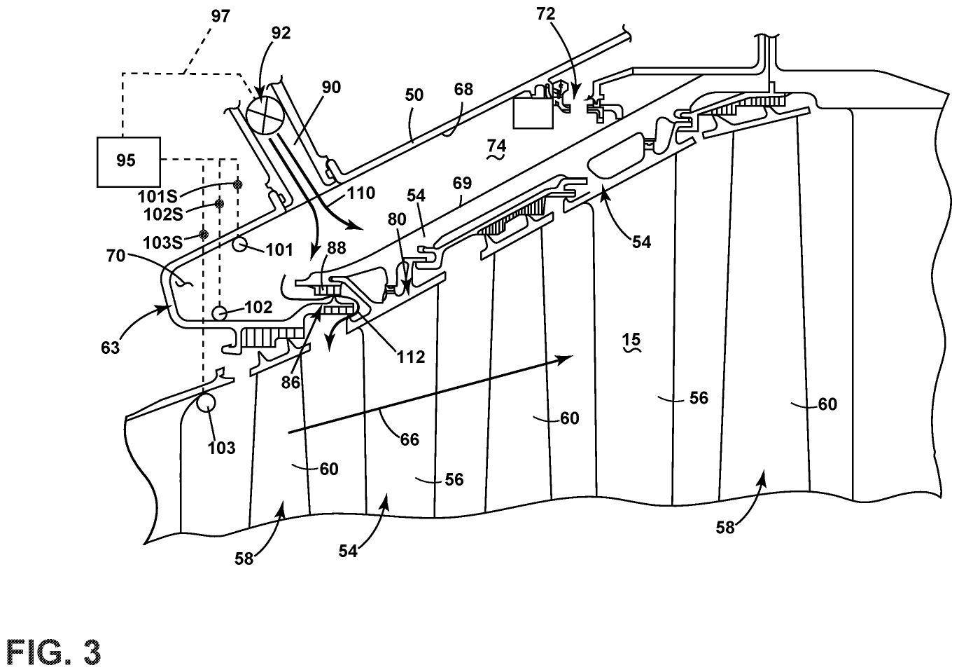

Referring now to FIG. 3, the cavity 74 is illustrated during a change in sealing status, performance, or function of the seal 72. The seal 72 is schematically illustrated with a hole or gap for visual clarity. It will be understood that the seal 72 can undergo such a change in status in a variety of ways, including, but not limited to, a material stress or failure such as a crack, a shift or displacement in mounting position, or a change in material property of the seal 72 during operation, or the like, that could alter a sealing performance or function in the cavity 74 within the engine 10.

It is contemplated that the first, second, and third signals 101S, 102S, and 103S can be utilized by the controller 95 to determine the change in sealing status within the cavity 74. It is contemplated that the controller 95 can determine the change in sealing status based on an absolute value, a comparison, or a rate of change as indicated by the first signal 101S, second signal 102S, or third signal 103S. It can be appreciated, for example, that a change in sealing status can cause a pressure drop within the cavity 74. Such a pressure drop can enable hot combustion gases from the main flow path 15 to enter the cavity 74 via the purge path 86, thereby causing environmental changes within the cavity 74.

In one example, the controller can compare the first signal 101S, indicating a sensed temperature within the cavity 74, against a threshold temperature value indicative of a nominal sealing status e.g. a normal temperature or standard operating temperature within the cavity 74. If the first signal 101S does not satisfy the threshold temperature value, the controller 95 can determine that a change in sealing status has occurred.

In another example, the controller 95 can compare a rate of change the second signal 102S, indicating a rate of change of sensed pressure within the cavity 74, against a threshold pressure rate indicative of a nominal sealing status e.g. a normal air pressure or standard operating air pressure changes within the cavity 74. If the second signal does not satisfy the threshold pressure rate, the controller 95 can determine that a change in sealing status has occurred. For example, if the rate of change of sensed pressure indicates a fast pressure drop that does not satisfy the threshold pressure rate, the controller 95 can determine that a change in sealing status has occurred.

In still another example, the controller can compare the first signal 101S against a threshold temperature value, the second signal 102S against a threshold pressure value, and the third signal 103S against a threshold temperature value. The controller can determine a change in sealing status if a majority of received signals do not satisfy their respective threshold values, e.g. if only the second signal 102S satisfies the threshold pressure value.

Based on the determined change in sealing status in the example of FIG. 3, the controller 95 can determine a needed supply of cooling air 110 to the cavity 74. In the illustrated example, the increased supply of cooling air 110 is shown using additional arrows compared to that illustrated in FIG. 2. It will be understood that an “increased supply” of cooling air 110 can refer to a faster flow rate through the inlet passage 90, a higher volumetric flow through the inlet passage 90, or an increased pressure of the cooling air 110 through the inlet passage 90. As the increased supply of cooling air 110 is provided to the cavity 74, it can also be appreciated that a sensed temperature can decrease and the sensed pressure can increase within the cavity 74.

In one non-limiting example of operation, the controller 95 can receive the first signal 101S indicating a temperature increase of 100° C. within the cavity 74, determine a current supply of cooling air 110 of 1 L/min, determine a needed supply of cooling air 110 of 2 L/min, and controllably operate the valve 92 to open and provide the needed supply of cooling air 110 to the cavity 74 such that the sensed temperature is reduced to satisfy a threshold temperature threshold, e.g. a reduction in temperature of 100° C.

It is further contemplated that the controller 95 can operate the valve 92 to provide cooling air 110 at a sufficient rate to form a purge flow 112 along the purge path 86. The purge flow 112 can flow out of the cavity 74, enter the main flow path 15, and mix with the combustion gases 66, thereby preventing ingestion of combustion gases into the cavity 74. In this manner, the engine 10 can continue to operate with the change in sealing status present within the cavity 74.

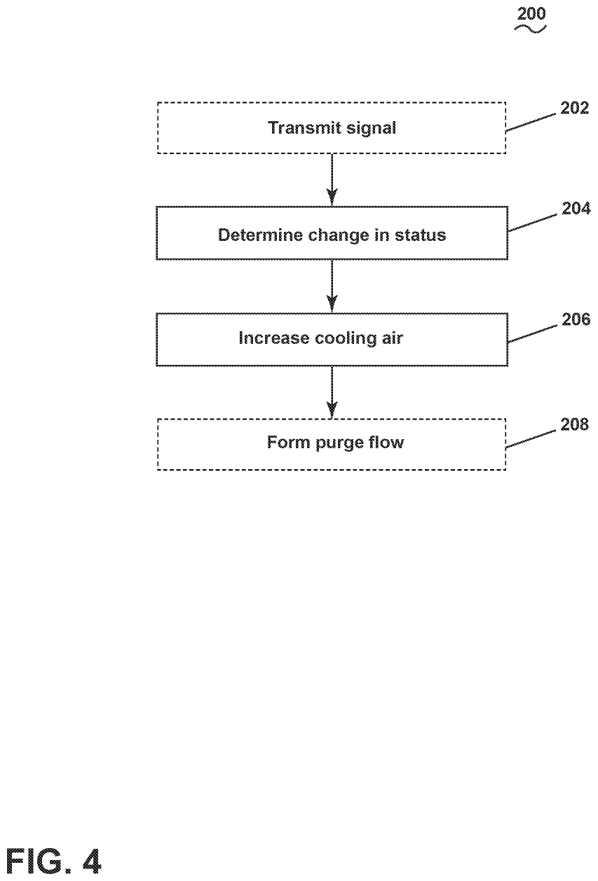

FIG. 4 illustrates a method 200 of operating the turbine engine 10. At 202 the method 200 can include transmitting a signal to a controller, including the first signal 101S, second signal 102S, or third signal 103S, to the controller 95, indicative of an environmental parameter within a cavity, such as the cavity 74, between the outer casing 50 and a rotor, such as the outer rotor 54, of the turbine engine 10. It will be understood that the method 200 can include at 202 transmitting any number of signals, including only one signal, indicative of an environmental parameter.

At 204, the method 200 includes determining a change in sealing status within the cavity, including the cavity 74. Determining the change in sealing status at 202 can include comparing the transmitted signal with a threshold value indicative of a nominal sealing status as described above. Additionally or alternatively, determining the change in sealing status at 204 can include comparing a rate of change of the transmitted signal with a threshold rate of change as described above.

At 206 the method 200 includes increasing a supply of cooling air, such as the cooling air 110, to the cavity based on the determined change in sealing status. Increasing the supply of cooling air at 206 can include controlling the valve 92 via the controller 95 to increase a flow rate of cooling air 110 as described above. At 208, the method 200 can include forming a purge flow, such as the purge flow 112, exiting the cavity via a purge path, such as the purge path 86, fluidly coupled to the cavity. The purge flow 112 can be mixed with combustion gases 66 flowing through the turbine engine 10 as described above.

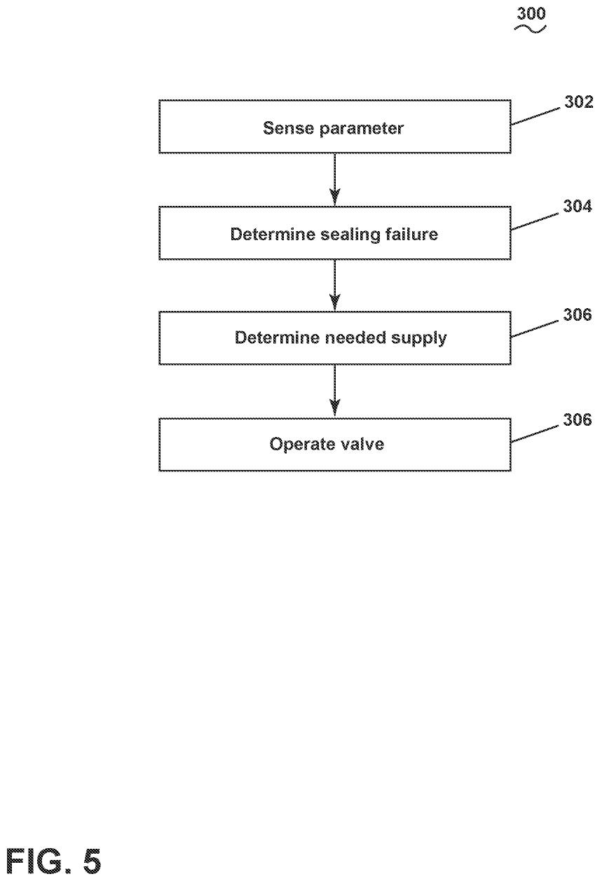

FIG. 5 illustrates another method 300 of operating a turbine engine, such as the turbine engine 10. At 302 the method 300 includes sensing a first environmental parameter within a cavity, including the cavity 74, within the turbine engine 10. The first environmental parameter can be indicated by any of the first signal 101S, second signal 102S, or third signal 103S as described above.

At 304 the method 300 includes determining a change in sealing status in the cavity based at least on the first environmental parameter. For example, the controller 95 can receive at least one of the first signal 101S, second signal 102S, or third signal 103S, and determine the change in sealing status based at least on the environmental parameter indicated therein as described above. At 306, the method 300 includes determining a needed supply of cooling air, such as the cooling air 110, to the cavity based on the determined change in sealing status. Determining the needed supply of cooling air 110 can include performing a comparison or other analysis on at least one signal, such as the first signal 101S, second signal 102S, or third signal 103S received by the controller 95. For example, the controller 95 can monitor or repeatedly receive the first signal 101S, second signal 102S, or third signal 103S, perform a comparison against a threshold value, and determine the needed supply of cooling air 110 based on the signals 101S, 102S, 103S and the determined change in sealing status. At 306, the method 300 includes operating a valve, such as the valve 92, fluidly coupled to the cavity 74 to provide the needed supply of cooling air 110.

Some additional operation examples of the turbine engine of the present disclosure will be described below in accordance with various aspects described herein. It will be understood that such examples are intended to be illustrative, and do not limit the disclosure in any way.

In one example of operation, four sensors are located within the cavity and configured to sense air pressure adjacent the inlet passage, air temperature adjacent the inlet passage, air pressure adjacent the purge path, and air temperature adjacent the purge path. The sensors can transmit signals indicative of their respective environmental parameters to the controller during operation of the turbine engine. The controller can determine that both the air pressure and air temperature adjacent the inlet passage satisfies respective temperature and pressure threshold values. The controller can also determine that both the air temperature and air pressure adjacent the purge path do not satisfy respective temperature and pressure threshold values. More specifically, the air temperature adjacent the purge path exceeds a maximum temperature threshold value, and the air pressure adjacent the purge path falls below a minimum pressure threshold value. The controller can determine that a change in sealing status has occurred within the cavity, due to encroaching hot gases from the purge path. The controller can determine a needed supply of cooling air such to provide for the sensed pressure adjacent the purge path satisfying the minimum pressure threshold value as well as forming a purge flow through the purge path. The controller can then operate the valve 92 to provide the needed supply of cooling air to the cavity. Furthermore, the controller can repeatedly monitor signals received from the four sensors and repeatedly perform comparisons against respective threshold values during operation of the engine 10 with the change in sealing status present in the cavity.

In another example of operation, two sensors are located within the cavity and configured to sense air temperature proximate to the inlet passage as well as air temperature proximate to the purge path. A third sensor is located in the main flow path and configured to sense combustion gas temperature. Signals from the three sensors are transmitted to the controller. The controller monitors the air temperatures and performs comparisons of each air temperature against a threshold temperature value indicative of nominal sealing status. The controller also determines a rate of change for each temperature, and performs a comparison on each rate of change compared to a threshold rate of change. In the event that a sensed temperature increases at a rate of change that does not satisfy the threshold value, e.g. the sensed temperature rises at 50° C./s whereas the threshold value is a maximum of 30° C./s, the controller can determine that a change in sealing status has occurred. Furthermore, the controller can correlate temperature signals from the third sensor in the main flow path with sensed temperatures from the first and second sensors within the cavity when determining that the change in sealing status has occurred. The controller can then operate the valve to increase a rate of cooling air supplied to the cavity based on the determined change in sealing status.

In another example of operation, a single sensor can be provided within the cavity and transmitting a single signal to a controller indicative of an environmental parameter within the cavity. More specifically, the signal can indicate a sensed temperature within the cavity. The controller can analyze the signal from the single sensor and determine whether a change in sealing status is present within the cavity. The determination by the controller can be based on a comparison against a threshold temperature value, threshold temperature range, or threshold temperature rate of change, or based on a lookup table, or based on a comparison with a previously sensed temperature during times when a change in sealing status was not present, or the like, or a combination thereof.

Aspects of the present disclosure provide for a variety of benefits. In contrast to traditional methods of handling sealing performance alterations within an engine wherein the engine is shut down, e.g. a planned component release during operation, the present disclosure provides for methods of operating a turbine engine having a change in sealing status without need of any such component release or engine shutdown. In an aircraft environment, the supply of additional cooling air and the formation of the purge flow provides for continued operation of the turbine engine having the change in sealing status until the aircraft lands. It can be appreciated that such operation can reduce repair times and costs, as no components are purposefully released within the engine, and therefore no additional repairs associated with such a release event would be necessary.

The monitoring of environmental parameters, e.g. temperature, within the cavity can additionally provide for fast determination of a change in sealing status or function by the controller as well as immediate action to compensate for or supplement the seal's functionality by way of controlling the valve and increasing the supply of cooling air to the cavity. Aspects of the present disclosure provide for improved safety in operation and reduced costs associated with maintenance of the turbine engine.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the invention are provided by the subject matter of the following clauses:

1. A method of operating a turbine engine, the method comprising determining a change in sealing status within a cavity at least partially defined between an outer casing and a rotor within the turbine engine, and increasing a supply of cooling air to the cavity based on the determined change in sealing status.

2. The method of any preceding clause, further comprising forming a purge flow exiting the cavity via a purge path fluidly coupled to the cavity.

3. The method of any preceding clause, further comprising mixing the purge flow with combustion air flowing through the turbine engine.

4. The method of any preceding clause, further comprising transmitting, via a first sensor, a first signal to a controller indicative of a first environmental parameter within the cavity.

5. The method of any preceding clause wherein the first environmental parameter comprises one of temperature or pressure.

6. The method of any preceding clause, further comprising comparing, via the controller, the first signal with a threshold value indicative of a nominal sealing status.

7. The method of any preceding clause, further comprising operating, via the controller, a valve fluidly coupled to the cavity to control a supply of the cooling air based on the comparing.

8. The method of any preceding clause, further comprising transmitting, via a second sensor, a second signal to the controller indicative of a second environmental parameter within one of the cavity or a main flow path through the turbine engine.

9. The method of any preceding clause wherein the second environmental parameter comprises one of temperature or pressure.

10. The method of any preceding clause wherein the determining the change in sealing status further comprises determining the change in sealing status based on the first environmental parameter.

11. The method of any preceding clause, further comprising operating, via the controller, a valve fluidly coupled to the cavity to increase the supply of cooling air.

12. The method of any preceding clause, further comprising sensing a first environmental parameter within the cavity at a first location, sensing a second environmental parameter within the cavity at a second location, and sensing a third environmental parameter within a main flow path through the turbine engine, wherein the determining the change in sealing status further comprises determining the change in sealing status based on at least one of the first environmental parameter, the second environmental parameter, or the third environmental parameter.

13. The method of any preceding clause wherein the increasing the supply of cooling air further comprises controlling a valve within an inlet passage fluidly coupled to the cavity.

14. A method of operating a turbine engine, the method comprising sensing a first environmental parameter within a cavity in the turbine engine, determining a change in sealing status in the cavity based at least on the first environmental parameter, determining a needed supply of cooling air to the cavity based on the determined change in sealing status, and operating a valve fluidly coupled to the cavity to provide the needed supply of cooling air.

15. The method of any preceding clause, further comprising sensing, via a second sensor located in the cavity, a second environmental parameter within the cavity.

16. The method of any preceding clause, further comprising sensing, via a third sensor, a third environmental parameter within a main flow path of the turbine engine.

17. The method of any preceding clause wherein the determining the change in sealing status further comprises determining the change in sealing status based on at least one of the first environmental parameter, the second environmental parameter, or the third environmental parameter.

18. The method of any preceding clause wherein at least one of the first environmental parameter, the second environmental parameter, or the third environmental parameter comprises an air temperature.

19. A turbine engine, comprising an outer casing having a casing surface bounding an interior, a first rotor located within the outer casing and having a rotor surface spaced from the casing surface, at least one seal extending between the casing surface and the rotor surface, a cavity at least partially defined between the rotor surface, the casing surface, and the at least one seal, an inlet passage fluidly coupled to the cavity, a controllable valve located within the inlet passage, at least one sensor located within the cavity and configured to provide a signal indicative of an environmental parameter, and a controller configured to receive the signal, to determine a change in sealing status of the at least one seal, and to operate the controllable valve based on the change in sealing status.

20. The turbine engine of any preceding clause, further comprising a purge path fluidly coupling the cavity and a main flow path through the turbine engine.

21. The turbine engine of any preceding clause wherein the purge path is at least partially defined by the rotor.

22. The turbine engine of any preceding clause, further comprising a counter-rotating section having the first rotor and a second rotor, wherein the first rotor is configured to rotate in a first direction and the second rotor is configured to rotate in a second direction opposite the first direction.

23. The turbine engine of any preceding clause wherein the counter-rotating section is located within a turbine section of the turbine engine.

24. The turbine engine of any preceding clause wherein the rotor is positioned radially outward of the second rotor.

25. The turbine engine of any preceding clause wherein the cavity is defined between the outer casing and the first rotor.

What is claimed is:

1. A method of operating a turbine engine, the method comprising:
determining a change in sealing status within a cavity at least partially defined between an outer casing and a rotor within the turbine engine; and
increasing a supply of cooling air to the cavity based on the determined change in sealing status.

2. The method of claim 1, further comprising forming a purge flow exiting the cavity via a purge path fluidly coupled to the cavity.

3. The method of claim 2, further comprising mixing the purge flow with combustion air flowing through the turbine engine.

4. The method of claim 1, further comprising transmitting, via a first sensor, a first signal to a controller indicative of a first environmental parameter within the cavity.

5. The method of claim 4 wherein the first environmental parameter comprises one of temperature or pressure.

6. The method of claim 4, further comprising comparing, via the controller, the first signal with a threshold value indicative of a nominal sealing status.

7. The method of claim 6, further comprising operating, via the controller, a valve fluidly coupled to the cavity to control the supply of the cooling air based on the comparing.

8. The method of claim 4, further comprising transmitting, via a second sensor, a second signal to the controller indicative of a second environmental parameter within one of the cavity or a main flow path through the turbine engine.

9. The method of claim 4 wherein the determining the change in sealing status further comprises determining the change in sealing status based on the first environmental parameter.

10. The method of claim 9, further comprising operating, via the controller, a valve fluidly coupled to the cavity to increase the supply of cooling air.

11. The method of claim 1, further comprising sensing a first environmental parameter within the cavity at a first location, sensing a second environmental parameter within the cavity at a second location, and sensing a third environmental parameter within a main flow path through the turbine engine, wherein the determining the change in sealing status further comprises determining the change in sealing status based on at least one of the first environmental parameter, the second environmental parameter, or the third environmental parameter.

12. A method of operating a turbine engine, the method comprising:
sensing a first environmental parameter within a cavity in the turbine engine;
determining a change in sealing status in the cavity based at least on the first environmental parameter;
determining a needed supply of cooling air to the cavity based on the determined change in sealing status; and
operating a valve fluidly coupled to the cavity to provide the needed supply of cooling air.

13. The method of claim 12, further comprising sensing, via a second sensor located in the cavity, a second environmental parameter within the cavity.

14. The method of claim 13, further comprising sensing, via a third sensor, a third environmental parameter within a main flow path of the turbine engine.

15. The method of claim 14 wherein the determining the change in sealing status further comprises determining the change in sealing status based on at least one of the first environmental parameter, the second environmental parameter, or the third environmental parameter.

16. The method of claim 14 wherein at least one of the first environmental parameter, the second environmental parameter, or the third environmental parameter comprises an air temperature.

17. A turbine engine, comprising:
an outer casing having a casing surface bounding an interior;
a first rotor located within the outer casing and having a rotor surface spaced from the casing surface;
at least one seal extending between the casing surface and the rotor surface;
a cavity at least partially defined between the rotor surface, the casing surface, and the at least one seal;
an inlet passage fluidly coupled to the cavity;
a controllable valve located within the inlet passage;
at least one sensor located within the cavity and configured to provide a signal indicative of an environmental parameter; and
a controller configured to receive the signal, to determine a change in sealing status of the at least one seal, and to operate the controllable valve based on the change in sealing status.

18. The turbine engine of claim 17, further comprising a purge path fluidly coupling the cavity and a main flow path through the turbine engine.

19. The turbine engine of claim 17, further comprising a counter-rotating section having the first rotor and a second rotor, wherein the first rotor is configured to rotate in a first direction and the second rotor is configured to rotate in a second direction opposite the first direction.

20. The turbine engine of claim 19 wherein the cavity is defined between the outer casing and the first rotor.
